(19) United States
(12) Patent Application Publication
(10) Pub. No.: US 2009/0204837 A1
(43) Pub. Date: Aug. 13, 2009

(54) Power control system and method

(76) Inventors: Udaykumar Raval, Sunnyvale, CA (US); Scott Alan Williams, San Jose, CA (US); Aleksandr Frid, San Francisco, CA (US); Shailendra Chafekar, San Diego, CA (US)

Correspondence Address: MURABITO HAO & BARNES LLP, Third Floor, Two North Market Street, San Jose, CA, 95113, US

(21) Appl. No.: 12/069,632

(22) Filed: Feb. 11, 2008

(51) Int. Cl. G06F 1/00

(52) U.S. Cl. 713/330

(57) ABSTRACT

An efficient and effective power control system method are described with expedited recovery from a reduced power state. In one embodiment, a present invention power control system includes performing a reduced power detection process for detecting a reduced power state, wherein the reduced power state is associated with an expedited recovery; performing a reduced power state entry process; performing a recovery detection process for detecting a recover indication event; and performing an expedited recovery process in accordance with detection of a recovery indication event. The reduced power state entry process comprises saving an expedited recovery information in registers of an always on domain and putting an external memory in self refresh mode to preserve a system context while a chip is turned off. The expedited recovery process comprises determining whether to proceed with the expedited recovery process; initializing memory controller registers and directing memory controller to exit self refresh; validating system context recovered from memory using keys stored in an always on domain; jumping to recovery instructions in memory; restoring operating system information and returning to operating system control.

### FIELD OF THE INVENTION

The present invention relates to the field of power control. More particularly, the present invention relates to a system and method for efficient power control with expedited recovery from a reduced power state.

### BACKGROUND OF THE INVENTION

Electronic systems and circuits have made a significant contribution towards the advancement of modern society and are utilized in a number of applications to achieve advantageous results. Numerous electronic technologies such as digital computers, calculators, audio devices, video equipment, and telephone systems facilitate increased productivity and cost reduction in analyzing and communicating data, ideas and trends in most areas of business, science, education and entertainment. Frequently, these activities involve significant information processing that typical consume significant amount of power. However, numerous devices have limited power supplies.

Advanced applications are creating ever greater demands on system performance. For example, the desired objective of numerous applications is to provide a visual presentation to a user (e.g., on a display or monitor), communicate with other devices, etc. Operations associated with these functions usually involve significant processing of large amounts of data at a rapid rate. One basic electronic component for performing most of the operations associated with these functions is a transistor. Transistors consume power when switching and are also susceptible to leakage current when not switching. As functionality increases in systems the frequency at which the transistors operate and the number of transistors are rapidly increasing with a corresponding exponential increase in power consumption.

Traditional attempts at power conversation are often limited and can adversely affect operations and/or user experience. Conventional attempts at powering down and up a system often result in delays from a user experience perspective. For example, when a conventional system is powered down and a user attempts to interact with the system the user typically looks at a blank screen waiting information to be displayed. Applications can also be adversely impacted by conventional powered down systems. For example, real time communication applications often have to delay transmission and/or attempt to retransmit information which can adversely affect the real time effect. In addition, the information may be dumped and lost permanently further deteriorating user experience.

### SUMMARY

An efficient and effective power control system and method are described with expedited recovery from a reduced power state. In one embodiment, a present invention power control system includes performing a reduced power detection process for detecting a reduced power state, wherein the reduced power state is associated with an expedited recovery; performing a reduced power state entry process; performing a recovery detection process for detecting a recover indication event; and performing an expedited recovery process in accordance with detection of a recovery indication event. The reduced power state entry process comprises saving expedited recovery information in registers of an always on domain and putting an external memory in self refresh mode to preserve a system context while a chip is turned off. The expedited recovery process comprises utilizing the information stored in the always on domain to begin recovery, initializing memory controller registers and directing memory controller to exit self refresh; validating system context recovered from memory using keys stored in an always on domain; jumping to recovery instructions in memory; restoring operating system information and returning to operating system control.

### DESCRIPTION OF THE DRAWINGS

The accompanying drawings, which are incorporated in and form a part of this specification, are included for exemplary illustration of the principles of the present and invention and not intended to limit the present invention to the particular implementations illustrated therein. The drawings are not to scale unless otherwise specifically indicated.

FIG. 1A is a block diagram of exemplary system in accordance with one embodiment of the invention.

FIG. 1B is a table of exemplary power states and corresponding power consumption indications in accordance with one embodiment of the present invention.

FIG. 2 is a block diagram of another exemplary system in accordance with one embodiment of the present invention.

FIG. 3 is a block diagram of exemplary non-power gated island in accordance with one embodiment the invention.

FIG. 4 is a block diagram of an exemplary always on power domain in accordance with one embodiment in the mention.

FIG. 5 is a block diagram of an exemplary power control method in accordance with one embodiment of the present invention.

FIG. 6 is a block diagram of an exemplary reduced power detection process in accordance with one embodiment of the present invention.

FIG. 7 is a block diagram of exemplary reduced power state entry process in accordance with one embodiment of the present invention.

FIG. 8 is a flow chart of an exemplary expedited recovery process in accordance with one embodiment of the present invention.

FIG. 9 is a block diagram of power control method in accordance with one embodiment of the present invention.

FIG. 10 is a table of exemplary actions of a power shut down or reduction process for a deep sleep state (e.g., LP0) in accordance with one embodiment of the present invention.

FIG. 11 is a table of exemplary actions of a power shut down or reduction process for a suspended power state (e.g., LP1) in accordance with one embodiment of the present invention.

FIG. 12 is a table of exemplary actions of a recovery process from a deep sleep state (e.g., LP0) in accordance with one embodiment of the present invention.

FIG. 13 is a table of exemplary actions of a recovery process from a suspended power state (e.g., LP1) in accordance with one embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one ordinarily skilled in the art that the present invention may be practiced without these specific details. In other instances, well known methods, procedures, components, and circuits have not been described in detail as not to unnecessarily obscure aspects of the current invention.

Some portions of the detailed descriptions which follow are presented in terms of procedures, logic blocks, processing, and other symbolic representations of operations on data bits within a computer memory. These descriptions and representations are the means generally used by those skilled in data processing arts to effectively convey the substance of their work to others skilled in the art. A procedure, logic block, process, etc., is here, and generally, conceived to be a self-consistent sequence of steps or instructions leading to a desired result. The steps include physical manipulations of physical quantities. Usually, though not necessarily, these quantities take the form of electrical, magnetic, optical, or quantum signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are associated with the appropriate physical quantities and are merely convenient labels applied to these quantities. Unless specifically stated otherwise as apparent from the following discussions, it is appreciated that throughout the present application, discussions utilizing terms such as “processing”, “computing”, “calculating”, “determining”, “displaying” or the like, refer to the action and processes of a computer system, or similar processing device (e.g., an electrical, optical, or quantum, computing device), that manipulates and transforms data represented as physical (e.g., electronic) quantities. The terms refer to actions and processes of the processing devices that manipulate or transform physical quantities within a computer system's component (e.g., registers, memories, other such information storage, transmission or display devices, etc.) into other data similarly represented as physical quantities within other components.

The present invention enables enhanced system performance while facilitating efficient and effective power control. In one embodiment, the present invention directs adjustments in the power state (e.g., full power, reduced power, off, etc.) of a system in response to various criteria (e.g., user interaction with a device, communication from other devices, etc.). In one exemplary implementation, the present invention also enables expedited recovery from a reduced power state. The present invention can also be Operating System agnostic and readily adaptable to accommodate a variety of implementations in different Operating System environments. The power control can be utilized for power conservation at a variety of levels and granularity. In one embodiment, portions of power conservation operations are distributed to a variety of modules (e.g., drivers, resource management module, etc.).

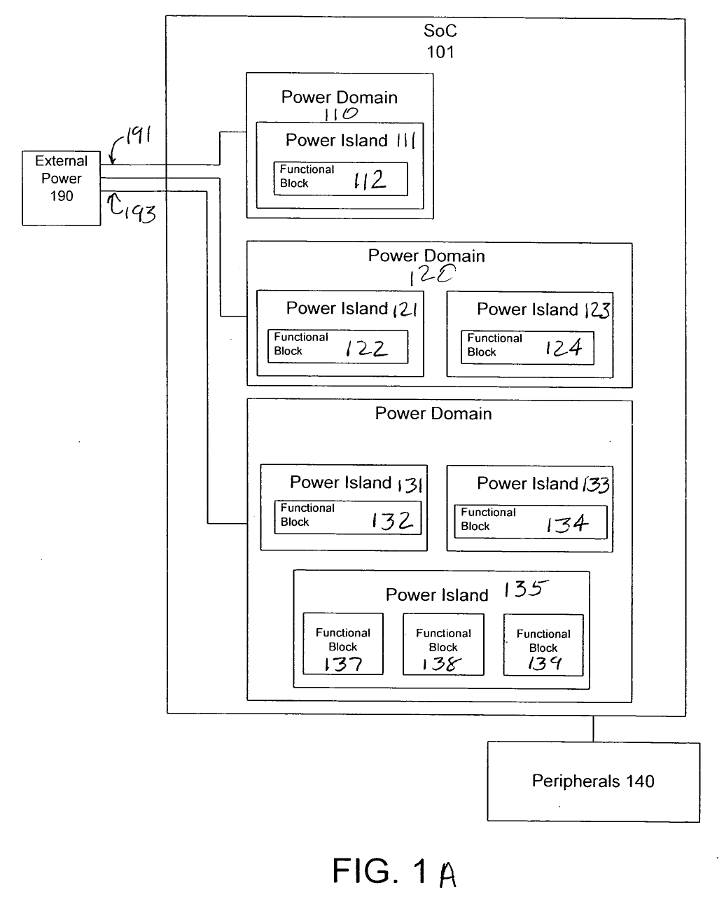

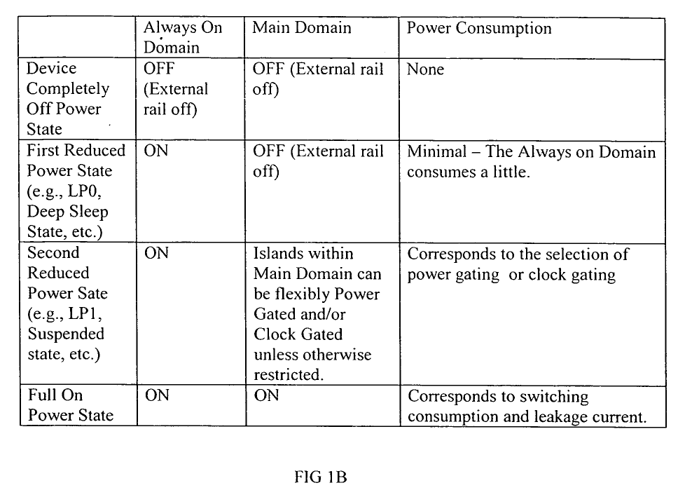

FIG. 1A is a block diagram of exemplary system 100 in accordance with one embodiment of the invention. System 100 includes external power source 190, peripherals 140 and system-on-a-chip (SoC) 101. While illustrated as a single block, it is appreciated that peripherals 140 can include a variety of peripheral or external devices (e.g., memory, communication interfaces, input devices, etc.). System-on-a-chip 101 includes a plurality of power domains 110, 120, and 130. The power domains include power islands that can be structured in a variety of configurations. In one embodiment, power domain 110 includes power island 111, power domain 120 includes power island 121 and power island 123, power domain 130 includes power island 131, power island 133 and power island 135. It is also appreciated that each of the power islands can include a variety of functional block configurations. For example, power island 111 includes functional block 112, power island 121 includes functional block 122, power island 123 includes functional block 124, power island 131 includes functional block 132, power island 133 includes functional block 134, and power island 135 includes functional blocks 137, 138 and 139.

It is appreciated that the power domains and power islands of system 100 can be implemented in a variety of architectural hierarchies. In one embodiment, power domain 110 is an always on domain and power domain 130 is a main power domain. It is appreciated that power control for the components of system 100 can be flexibly implemented to enable realization of different power states at various levels and/or granularity. With respect to different power states, it is appreciated that the “always on” domain as used herein is not necessarily literally always on. In one embodiment, the always on domain can not be turned off. In one embodiment, the “always on” domain is not powered up if a device is in a completely off state. In one exemplary implementation, the completely off state is entered when a user turns off a device (e.g., turns a device off button to an off position, disconnects power source, etc.). However, if a device is turned on by a user (e.g., a user activates a device power on button, connects power source, etc.) the always on domain is always on. While the always on domain can be designed to have a relatively low nominal power consumption, in one embodiment the always on domain is not subject to dynamic power reduction other than an indication from a user to completely turn off the device. For example, the always on domain may consume minimal nominal power due to a relatively small number of transistors, small footprint and/or low operating frequency, but the nominal power is not further dynamically reduced due to reduced power state changes as part of a power conservation scheme directed at other power domains.

The components of system 100 cooperatively operate to facilitate efficient and effective power management of components within the system. Power domains can be independently turned on and off or power gated. In one exemplary implementation, power consumption by each power island within a power domain can also be independently controlled within the island (e.g., power gated, clock gated, etc.). In one embodiment, each functional block is associated with a particular function or end-use application (e.g., phone, internet application, word processor, etc.). The power consumption functional blocks within a power island can be controlled based upon utilization of the function or end-use application.

It is appreciated that a variety of power control mechanisms can be utilized. For example, power islands can be power gated and/or clocked gated. As a general proposition, if a region is clock gated power is not consumed by switching transistors but can be consumed by leakage current occurrence. Also as a general proposition, if a region is power gated power is not consumed by switching transistors but there can be a minimal leakage current down to no leakage current. In one exemplary implementation, if a particular region or island is power gated, the “power gated leakage current” impact on power consumption is 30% of the clock gated leakage current power consumption impact associated with same region when it is clock gated.

In one embodiment, system 100 can enter and exit the plurality of exemplary power states and exemplary corresponding power consumption indications are show in FIG. 1B. In a device completely off state the always on domain and main domain are off with no power consumption. In a first reduced power state (e.g., LP0, deep sleep power state, etc.) the always on domain is on and the main domain is off (e.g., a rail to the main domain is switched off, power gated off, etc.). In a second reduced power state (e.g., LP1, suspended power state, etc.) the always on domain is on and the islands within the main domain can be flexibly power gated and/or clock gated unless otherwise restricted. For example, an island can be designated with an additional restriction as a non-power gated island and the island is not individually power gated but can be clock gated. The power consumption in the second reduced power state varies depending upon which islands are power gated and/or clock gated.

With reference back to FIG. 1A, each power domain is coupled to an external power rail in one exemplary embodiment. For example, power domain 110 is coupled to power rail 191 and power domain 130 is coupled to power rail 193. Each power rail supplying the respective power domains can be turned off or power gated.

The always on domain can also facilitate expedited recovery from a reduced power state. In one embodiment, the always on power domain includes components for receiving indications of power alteration trigger events, registers for storing information associated with power alteration operations, and information for recovering or powering up from reduced power states. The recovery information stored by the always on domain can facilitate expedited recovery from a reduced power state. In one exemplary implementation, the always on domain stores context information associated with the operating status of components within system 100. The context information can be a minimal amount of information associated with restoring power and operations to selected components (e.g., an internal ROM, an external RAM interface, etc) and then utilizing those selected components to restore the power and operations to other components.

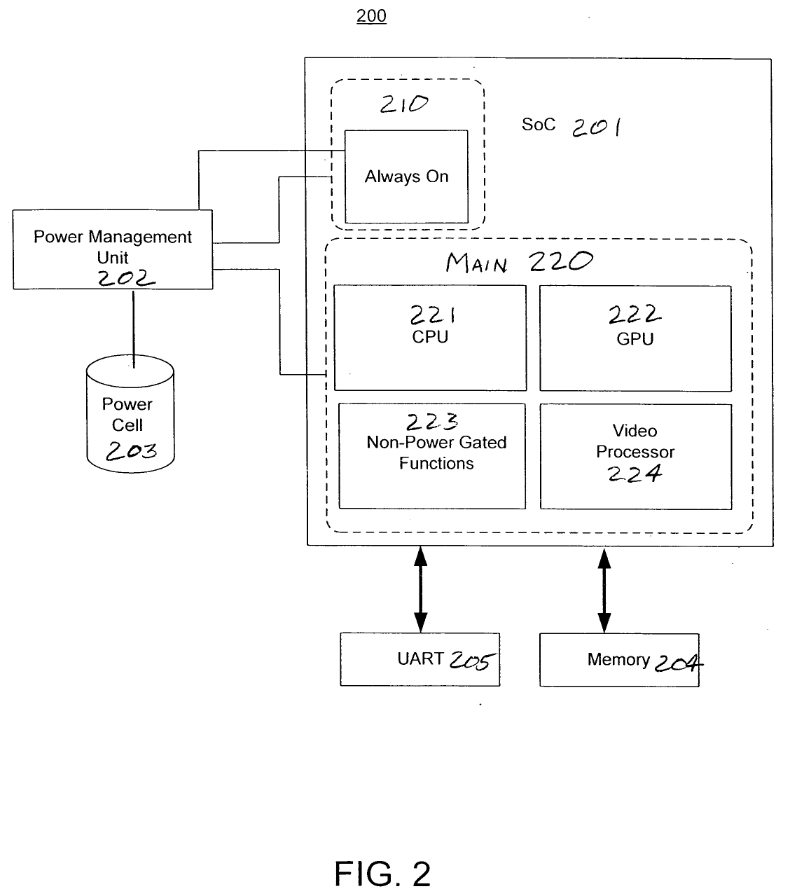

FIG. 2 is an exemplary block diagram of system 200 in accordance with one embodiment of the present invention. System 200 includes system-on-a-chip 201, power management unit 202, power source 203 (e.g., power cell, battery, connection to a continuous or utility power, etc.), memory 204 and UART 205. The system-on-a-chip 201 includes always on power domain 210 and main power domain 220. The main power domain 220 includes central processing (CPU) island 221, graphics processing island (GPU) island 222, video processor island 224, and non-power gated island 223.

It is appreciated that system 200 can be implemented in a variety of configurations. In one embodiment, CPU island 221 includes a core processor complex (e.g., a core processor, a memory controller, a level 1 cache, a bus bridge component, etc.). In one embodiment, system 200 also includes a video encoder island. The video processor island 224 can be a video encoder island can include a video encode component, an image signal processor (ISP), video input module (VI), post processing (EPP), camera sensor interface (CSI), etc. The graphics processing island 222 can be a three dimensional processing island. It is appreciated that two dimensional processing can be separated out and included in another island. In one exemplary implementation, the non-power gated island 223 can includes an audio video processor, two dimensional processing components, a display, an internal random access memory (IRAM), video decoding engine, memory controller, level 2 cache, other peripherals, etc. While in one embodiment the non-power gated island is not power gated independently as the other islands within main power domain 220 can be, if the power to the entire main domain main power domain 220 is cut off or gated off (e.g., at the main rail or supply) the non-power gated island (NPG) is also effectively turned off since it is included in the main domain 220.

The components or system 200 cooperatively operate to implement efficient and effective power management control. Always on component 210 stores information associated with power states of components and with initiation of an expedited recovery from a reduced power state. Power management unit 202 directs the expedited recovery from the reduced power state based upon information from the always on component. Memory 204 stores full expedited recovery information in a self refresh mode and forwards the information to a resource management module in response to the initiation of the expedited recovery from the reduced power sate.

In one embodiment, the information stored in the always on domain for expedited recovery from a reduced power state includes a warm boot flag, a pointer to recovery code, recovery code validation information, pointer to context, context validation information, memory controller configuration, phase lock loop frequency and settling time, and power management unit safe voltage and worst case delay. In one exemplary implementation the context information includes processor and peripheral register information for interaction with the operating system in a state corresponding to last operational state before power reduction. Memory 204 can be a DRAM for storing a portion of instructions associated with the expedited recovery from the reduced power sate. Memory 204 enters a self refresh state upon entry of the reduced power state. In one embodiment, system 200 also includes a boot ROM (not shown) for storing a portion of instructions associated with the expedited recovery from the reduced power sate.

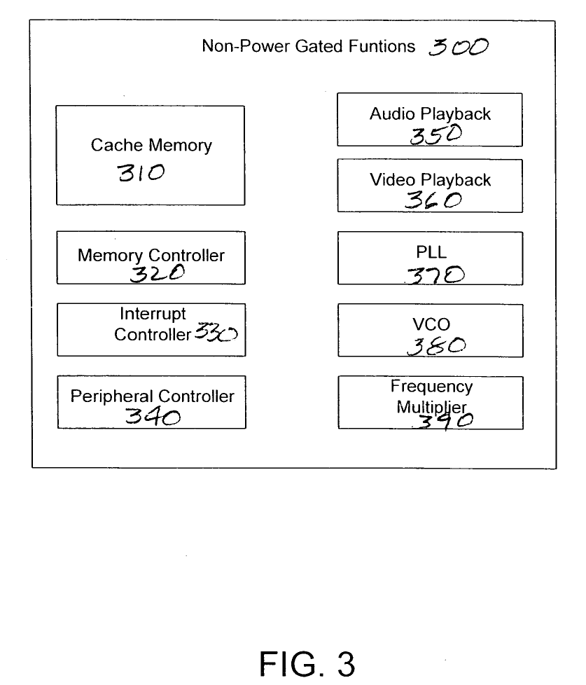

FIG. 3 is a block diagram of exemplary nonpower gated island 300 in accordance with one embodiment the invention. Nonpower gated island 300 is similar to nonpower gated island 223. Nonpower gated island 300 includes cache memory 310, memory controller 320, interrupt controller 330, peripheral controller 340, audio playback 350, video playback 360, phase locked loop 370, voltage controlled oscillator 380, and frequency multiplier 390.

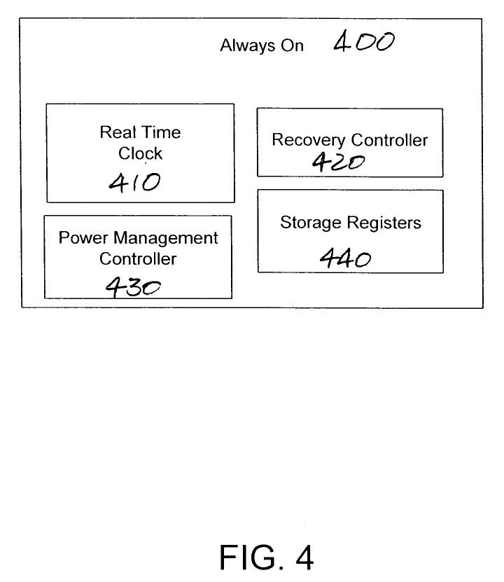

FIG. 4 is an exemplary block diagram of always on power domain 400 in accordance with one embodiment in the mention. Always on power domain 400 is similar to always on domain 210. Always on domain 400 includes a real-time clock (RTC) component 410, recovery controller 420, power management controller (PMC) 430, and storage registers 440. The components of always on domain 400 cooperatively operate to facilitate power reduction and expedite recovery. Real-time clock 410 provides a continuous clock signal during the full power and the suspended or reduced power states. Recovery controller 420 receives recovery initiation trigger event indications and initiates recovery from a reduced power state. In one exemplary implementation, recovery controller 420 includes a keyboard controller (KBC) for sensing user activity with a keyboard. It is appreciated, recovery controller 420 can receive a variety of initiation or trigger indications (e.g., form peripheral devices, communication interface, UART, etc.). Power management controller 430 interacts with other components on chip and off chip to direct recovery from a reduced power state including expedited recoveries. Storage registers 440 store reduced power state information and expedited recovery information.

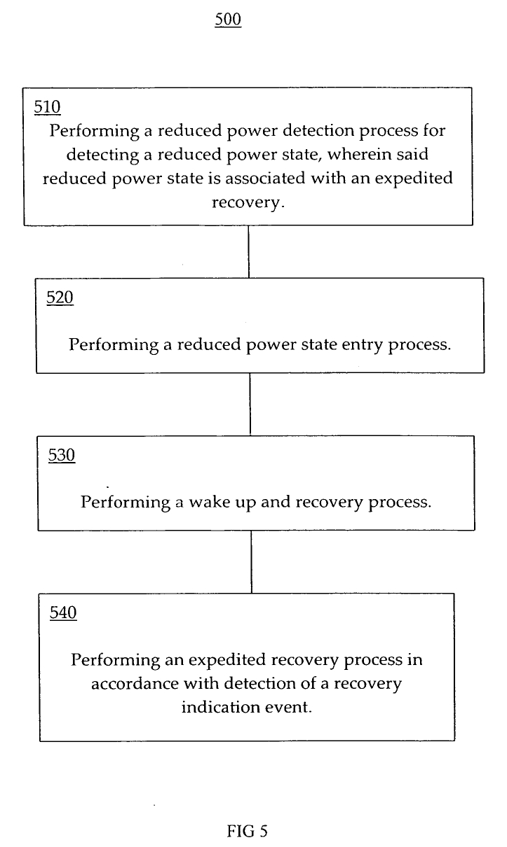

FIG. 5 is a block diagram of power control method 500 in accordance with one embodiment of the present invention. In one embodiment, the power control method is operating system agnostic and is compatible with a variety of operating systems.

In block 510, a reduced power state entry detection process for detecting conditions indicating a reduced power state entry is performed. In one embodiment, activities and/or anticipated activities of components of a system (including peripherals) are examined. If the examination indicates the system is at a reduced level of activities corresponding to a reduced power state the process proceeds to block 520. In one exemplary implementation, an indication of the level of the reduced power state is forwarded based upon the level of activities and/or anticipated activities. In one embodiment, the indicated reduced power state is associated with an expedited recovery.

In block 520, a reduced power state entry process is performed. In one embodiment, there is a plurality of reduced power states. Each one of the plurality of reduced power states can be associated with a different power consumption level. In one exemplary implementation, different reduced power states alter the operations and power consumption of different components within the system differently. The reduced power state entry process can vary depending upon the level of the reduced power indication received from block 510.

In block 530, a recovery detection process for detecting a recover indication event is performed. In one embodiment, the wake up events from a deep sleep power reduction state (e.g., LP0, etc.) include: a keypad press indication received by the keyboard controller (KBC), Internal RTC event, Baseband Interrupt from a communication interface (e.g., a UART/SPI incoming call, etc), Bluetooth Interrupt (e.g., UART/I2S), WLAN interrupt (e.g., a secure digital input output SDIO), PMU Interrupt (external RTC event, charger plug-in, etc.), PMU PWR FAIL Interrupt (e.g. Low battery), USB Detect Interrupt, Memory Card Insertion Interrupt (e.g., SDIO), Flip Opened Interrupt (e.g., general purpose input output GPIO), and Headset Detect Interrupt (e.g., Jack Sense, GPIO, etc.)

In one embodiment the propagation of deep sleep entry events initiates in the always on domain. The wake up events can be detected by utilizing special pads placed in the always on (AO) domain. These pads are coupled to various lines that cause some of the wake up events mentioned above. Registers in the PMC store the status of these lines, which software can read to determine the wake source. The AO domain can also include registers to mask the wake up events. Wake up events can be combined to generate interrupts for both the PMU and the processor cores. After a wake up event is generated, the PMU powers up the MAIN domain. This will provide a power on reset to the SoC. The system will exit LP0 mode, and can disable future generation of wake up events. In one embodiment, the wake up events are routed to both power management controller 430 and interrupt controller 330. When the system is fully functional, an ISR takes care of further processing. The ISR should recognize the interrupt is from the AO wake event, read the actual source of the interrupt from the appropriate PMC registers and schedule the interrupt service thread (IST) for that driver.

In block 540, an expedited recovery process in accordance with detection of a recovery indication event is performed. Verifying the checksum of the restore context is performed before any use of that context data. That puts this activity before the branch to stored address in DDR memory where recovery code is located. This is done to prevent someone from clipping onto the DDR memory and externally modifying its contents in an attempt to subvert security.

In one embodiment, the audio video processor recovery sequence is handled in the audio video execution environment and the audio video “driver” from the perspective of the CPU and Operating System. The audio video processor contexts can be saved before moving to LP0 state. In one exemplary implementation, when the driver is woken up again, it takes care of restoring its context in the arm boot scenario.

In one embodiment instructions or software code that programs PLLs and PMU is put in DDR memory, to have greater flexibility. These two operations can be done in parallel, so the total wait is reduced.

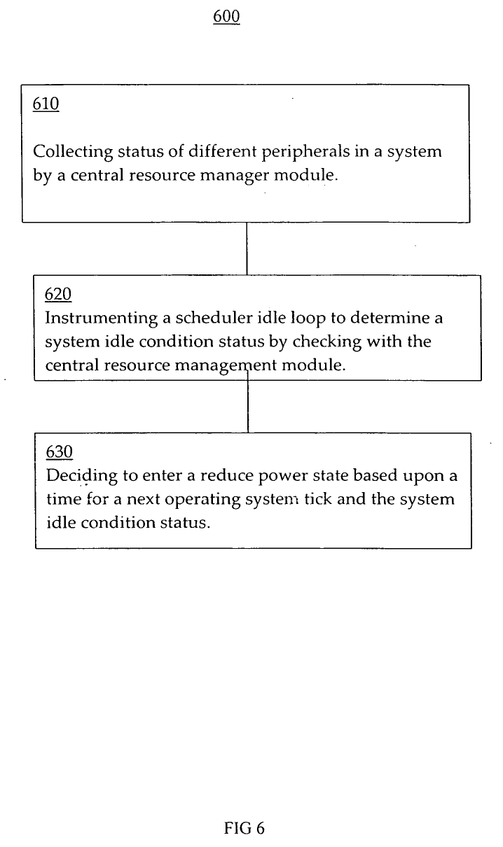

FIG. 6 is a block diagram of reduced power detection process 600 in accordance with one embodiment of the present invention.

In block 610, status of different peripherals in a system is collected by a central resource manager module. In one embodiment, drivers are responsible for monitoring their own power level and reporting to the resource manager module.

Some power reduction operations are distributed to the drivers and each driver registers with a central resource manager and notifies the central resource manager about its power state. The resource manager can recognize system idle conditions when the register drivers have reported a reduced power state. The central resource manager can also recognize a system active state when at least one of the registered drivers reports full power state. The central resource manager can detect a system power state change and update accordingly the power state variable in a memory or register space share with the CPU idle loop. Thus the central resource manager can be implemented independently of the Operating System power manager and facilitates Operating System agnostic implementation of the power reduction operations. Additional information on power reduction control distribution to drivers and interaction with the central resource manager is described below.

In block 620, a scheduler idle loop is instrumented to determine a system idle condition status by checking with the central resource management module.

In block 630, a decision regarding entry to a reduce power state based upon a time for a next operating system tick and the system idle condition status is made.

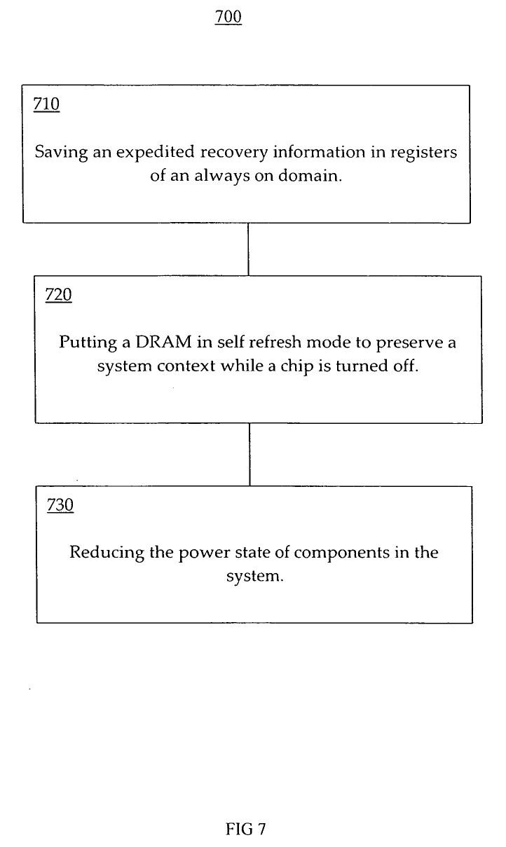

FIG. 7 is a block diagram of exemplary reduced power state entry process 700 in accordance with one embodiment of the present invention.

In block 710, expedited recovery information is saved in registers of an always on domain. In one embodiment, the expedited recovery information comprises a reduced power state recover indication, system context information, a recovery code address indication, and recovery code validation information. In one exemplary implementation, the system context information comprises CPU status information, peripheral status information and other component information associated with restoring a system to a state to continue operations in an orderly sequence after powering up from the reduced power state.

In block 720, a memory storage area is prepared for storage of recovery information associated with a reduced power state entry. In one embodiment, an external memory (e.g., DRAM, flash etc.) is utilized to store the recovery information. The memory (e.g., DRAM, etc.) can be put in self refresh mode to preserve a system context while a chip is turned off.

In block 730, a power state of components within the system are reduced. It is appreciated that a variety of reduced power states can be implemented. In one embodiment, the system has two reduced power states including a deep sleep power state and a suspend power state. The deep sleep power state and the suspend power state impact different power domains differently.

In one embodiment of the deep sleep power state (e.g., LP0, etc.), power to a main domain is cut off. In one exemplary implementation, cutting off power to the main domain includes cutting off power to a CPU island (including the CPU L1 cache, an Audio Video Processor and its associated cache, etc), a video encoder island, a graphics processing island (e.g., three dimensional processor, etc.) and a non-power gated island. Level 2 cache can also similarly be powered down. Phase lock loops and crystal oscillator can also be turned off. The always on domain is powered through and components (e.g., PMC, KBC and RTC) within the always on domain are “active”. The always on domain can be run through a clock within the always on domain (e.g., a relatively low frequency clock compared to other system clocks). An external memory can be put in self refresh mode.

In one embodiment of the suspend power state (e.g., LP1, etc.), power to a main domain is not cut off. The CPU island (e.g. processor core complex, etc.) is power gated. However the CPU L1 cache preserves its state though. The CPU L2 cache is clock gated. In an alternate implementation the caches can be power gated for increase power reduction. The video encoder (VE) and three dimension (TD) islands are power gated. Some components (e.g., an audio video processor, etc.) can be put in a HALT state. The audio video processor cache can be disabled and clock gated. External memory can be put in a self refresh mode. An interrupt controller and interrupt controller can be on. Phase lock loops can be off and system can run at the crystal oscillator frequency. Some modules can have clocking enable by their drives to be able to wake on a protocol interrupt. Functional blocks within a non-power gated island can be clock gated. The always on domain is powered through and components (e.g., PMC, KBC and RTC) within the always on domain are “active”.

In one exemplary implementation of the suspend sleep state (e.g., LP1), an audio video processor island clock gated and can be woken up to carry out a task. The audio video processor can be woken up by the central processing unit (e.g., when a task, interrupt, etc. is to run on the audio video processor). The audio video processor can be a slave of the central processor from a software design perspective and is not expected to process external interrupts.

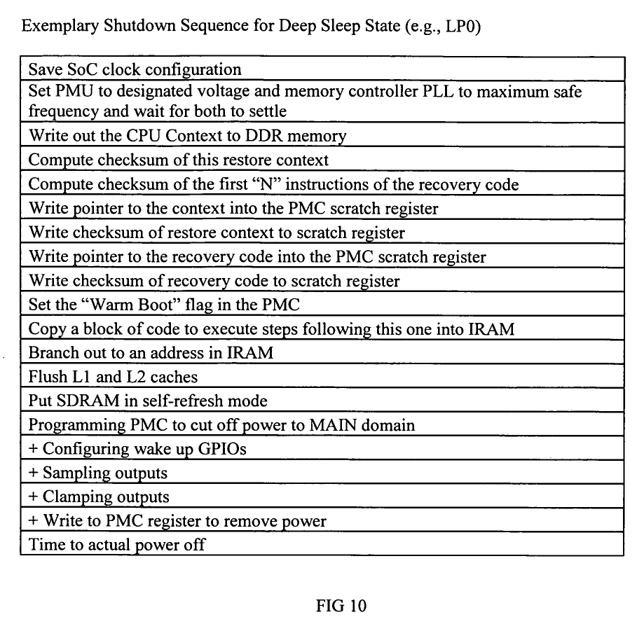

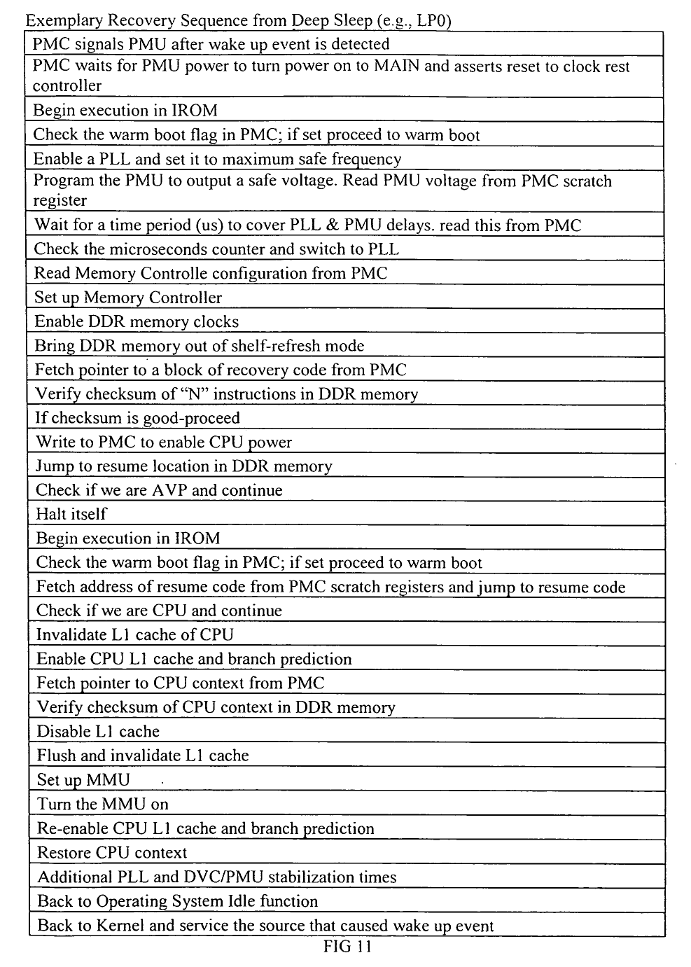

FIG. 10 is a table of exemplary actions of a power shut down or reduction process for a deep sleep state (e.g., LP0) in accordance with one embodiment of the present invention. FIG. 11 is a table of exemplary actions of a power shut down or reduction process for a suspended power state (e.g., LP1) in accordance with one embodiment of the present invention.

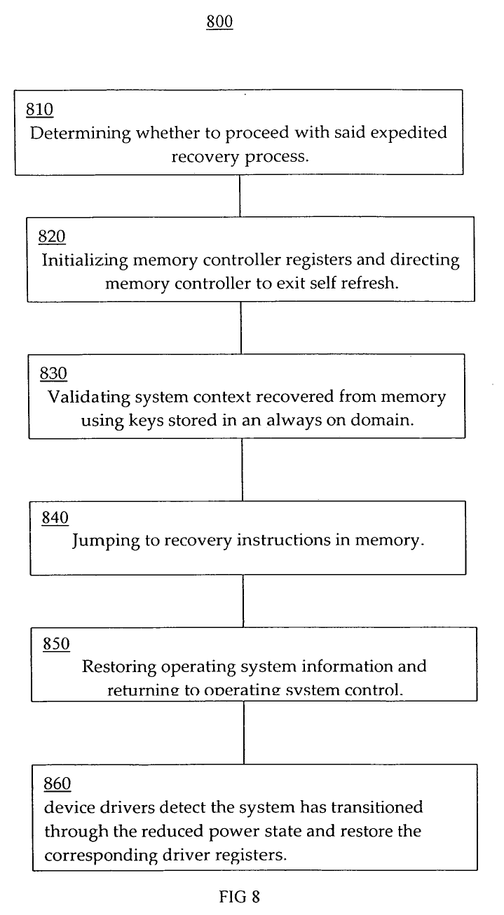

FIG. 8 is a flow chart of an exemplary expedited recovery process 800 in accordance with one embodiment of the present invention. In one embodiment, an expedited recovery process facilitates fast recovery from a reduced power state so that an Operating System is not impacted by a recovery delay.

In block 810, a determination is made whether to proceed with the expedited recovery process. In one embodiment, determining whether to proceed with the expedited recovery process includes checking an expedited recovery indication in an always on domain and proceeding with the expedited recovery process if the expedited recovery indication is set. In one exemplary implementation, the proceeding with the expedited recovery process includes indicating an expedited recovery transition to a central resource management module.

In block 820, memory controller registers are initialized and the memory controller directed to exit self refresh.

In block 830, system context recovered from memory is validated using keys stored in an always on domain. In one embodiment, a comparison of a checksum of the context information received from memory and the information stored in an always on register is made. In one exemplary implementation, the checksum of restoration code retrieved from memory is validated against the checksum value stored in the always on domain. If the checksum or the restoration information and/or code does not match the value stored in a register in the always on domain (e.g., because of memory corruption or external hacking), the restoration can't proceed and the device performs a cold reset to preserve the integrity of the device.

In block 840, a jump to recovery instructions in memory is made. In one embodiment the jump to the recovery instruction is to an external memory after exiting the self refresh state.

In block 850, operating system information is restored and control is returned to operating system. In one embodiment, the restoring operating system information comprises restoring processor and peripheral register information for interaction with the operating system in a state corresponding to last operational state before power reduction. In one embodiment, processor general purpose register information, coprocessor register information and optional vector floating point register information is restored. The recovery instruction can also direct notification to the resource manager module that indicates the recovery state transition.

In block 860, device drivers detect the system has transitioned through the reduced power state and restore the corresponding driver registers (e.g., peripheral registers, etc.).

In one embodiment, an expedited recovery process is utilized to wake up from a deep sleep reduced power state (e.g., LP0, etc.). Exit from the LP0 is initiated after detecting a wake up event. The process of going back to the fully operational state from a reduced power state LP0 can be referred to as a warm boot 0 (WB0). Since the main can be powered down during LP0, wake up signals can be re-routed to a power management unit interface (PMC) in the always on domain for detection. After the wake up event is detected, the state of the system is the CPU, graphics processing and video encoding island are power gated, interrupt controllers are on. The crystal oscillator is on and is the clock source for processors. The phase lock loops and clock doublers are disabled. The rest of the NPG island is either clock gated or on, depending on the default power on reset state. The external memory can be in self refresh mode.

In one embodiment, an expedited recovery process is utilized to wake up from a suspend reduced power state (e.g., LP1, etc.). Exit from the LP1 is initiated after detecting a wake up event. The process of going back to the fully operational state from a reduced power state LP1 can be referred to as a warm boot 1 (WB1). The wake up events out of LP1 can be “normal” interrupts since the interrupt controller is active. After the wake up event is detected, the state of the system is the CPU island is powered, the graphics island and video encoding islands are power gated. Some processors can be halted. Interrupt controllers are on. The crystal oscillator is on and is the clock source for the processors. The phase lock loops and doubler are disabled. Rest to the NPG island is either clock gated or on, depending on their default power on reset state. The external memory is in self-refresh mode.

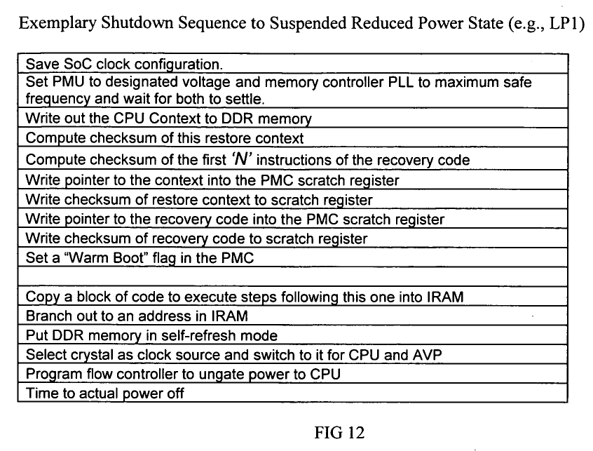

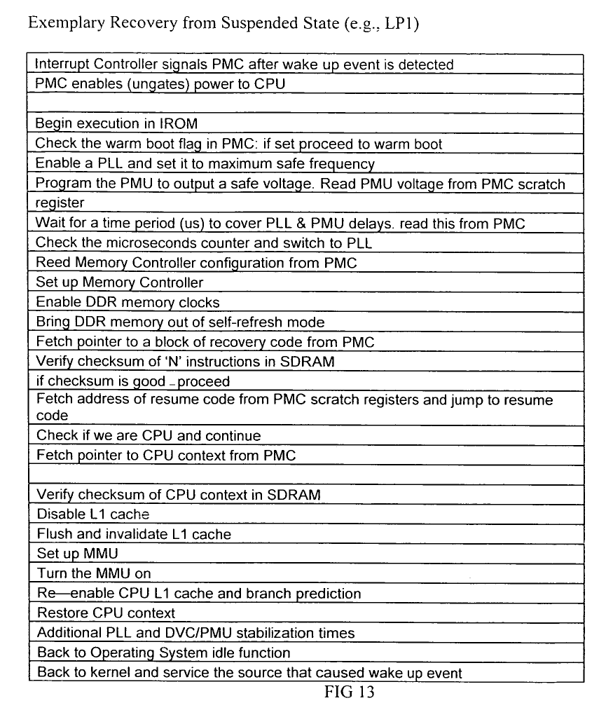

FIG. 12 is a table of exemplary actions of a recovery process from a deep sleep state (e.g., LP0) in accordance with one embodiment of the present invention. FIG. 13 is a table of exemplary actions of a recovery process from a suspended power state (e.g., LP1) in accordance with one embodiment of the present invention.

In one embodiment, power state alterations or power reductions are performed during Operating System Kernel idle states. In one exemplary implementation, decisions to enter a reduced power state are made based upon a “user timeout” timer, device driver activity and indication of anticipated activity according to the Operating System. In one embodiment, there 4 reduced power states.

The first reduced power state is entered if the “User Timeout” has not expired or device drivers are active or the indication of anticipated activity is lees than a second predetermined idle time. In the first reduced power state the central processor is halted. In this state the flow controller wakes up the central process when there is an interrupt. The power states of other functional blocks and/or power islands are not altered and remain in the “present” power state. In one exemplary implementation the “present” power state is dictated by usage patterns. An audio video processor is handled similarly. Phase lock loops may or many not be on. The system can keep running at whatever clock rate it was at.

The second reduced power state is entered if the “User Timeout” has not expired or device drivers are active or the indication of anticipated activity is greater than the second predetermined idle time but less than a first predetermined idle time. In the second reduced power state the central processor is power gated. In the second power state the flow controller wakes up the central processor when an interrupt occurs. The power states of other functional blocks and/or power islands are not altered and remain in the “present” power state. In one exemplary implementation the “present” power state is dictated by usage patterns. An audio video processor is handled similarly. Phase lock loops may or many not be on. The system can keep running at whatever clock rate it was at. In one exemplary implementation, wakeup or transitioning to full power state or full on mode is the farthest from the second power state.

The third and forth power state correspond to a suspend sleep (e.g., LP1) and deep sleep state (e.g., LP0) respectively. The third reduced power state is entered if the “User Timeout” has expired and device drivers are not active or the indication of anticipated activity is greater than the first predetermined idle time but less than a third predetermined idle time. The forth reduced power state is entered if the “User Timeout” has expired and device drivers are not active or the indication of anticipated activity is greater than the third predetermined idle time.

In one embodiment, power reduction operations are distributed. In one exemplary implementation, device drivers actively participate in the power management. For example, device drivers can actively monitor activities of associated components and either disable them (e.g., disable their on-chip controllers, external interfaces, etc.) or gate the clocks off when not needed or not in use. The device drivers can and enable them (e.g., enable their on-chip controllers, external interfaces, etc.) or clock then when needed or in use. In one exemplary implementation, device drivers are aggressive in managing associated component power consumption. In one embodiment, a device driver can disable their on-chip controllers.

In one embodiment, device drivers that are capable of controlling corresponding component power consumption are detected. Device drivers that are capable of controlling corresponding component power consumption do not obey Operating System power manager commands to turn on. For example, USB port divers can detect whenever a component is inserted or removed and do not need to enable the USB interface when not needed. Similarly a memory card driver can detect when a card is inserted in the socket and removed. Device drivers that are not capable of controlling corresponding component power consumption relay on Operating System Power Manager and/or Power System Manager commands to turn on or off (e.g., power manager time out events, etc).

In one embodiment, drivers include a shim layer, a device driver or driver development kit and resource manager module components of on-chip controllers in the non-power gated island, the video encoder and three dimensional functional blocks, and the audio video processor execution environment. The audio video execution environment can be represented by an audio video processor driver running on the central processor which keeps track of its status. The drivers can interact with the resource manager to store their current status (e.g., whether they are active, suspended, etc.). Before entering a reduced power state the driver store their context information if required.

In one embodiment, responsibility for controlling the state of the AVP, VE, TD and other block in the NPG island lies with the individual device drivers. It should be noted that controlling VE and TD power islands may have to be done by the centralized resource manager as these resources can be shared and individual drivers may not know about other users. The responsibility for managing the state of the audio video processor is with the execution environment of that processor. In one exemplary implementation it can have a mechanism to detect it equivalent of kernel idle mode and simply put itself in a HALT state. For the audio video processor, going into a “suspended” state means storing all the registers and flushing the cache. How and when to store the context is handled by the audio video processor execution environment. The audio video processor can do so before entering the HALT mode if there are no tasks scheduled for the audio vide processor. Alternatively, when going into the LP0 mode, the CPU can send a message to AVP to store its context. When a wakeup event is received the ware boot code uses the appropriate function to restore deriver contexts.

In one embodiment, an Operating System idle function is informed of the status of the components, the AVP and hardware accelerators through a shared memory area. In one exemplary implementation, this is done through the resource manager.

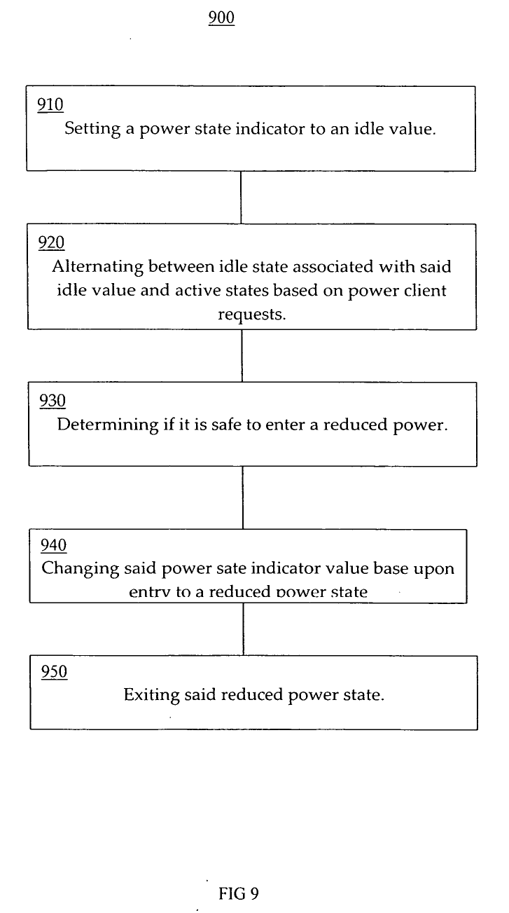

FIG. 9 is a block diagram of power control method 900 in accordance with one embodiment of the present invention. In one embodiment, power control method 900 sets power state indicators and utilizes the power state indicators to determine a reduced power state entry and appropriate recovery process. In one exemplary implementation a power state indicator indicates if a system is in a full power state or an expedited recovery full power state mode.

In block 910 a power state indicator is set to an idle value). In one embodiment the power state indicator is set to an idle value is set by a central power manager.

In block 920, alternate between idle state associated with the idle value and active states based on power client requests. In one embodiment, the power state alternations are performed by the central power manager.

In block 930 a determination is made if it is safe to enter a reduced power state based on the power sate indicator. In one embodiment, the determination is performed by a CPU idle loop.

In block 940 a power sate indicator value is changed based upon entry to a reduced power state. In one embodiment, upon entry to the reduced power state changing the power state indicator to correspond to the reduced power state. In one embodiment, the power sate indicator value change is performed by a CPU idle loop.

In block 950, a reduced power state is exited. In one embodiment, upon exiting the reduced power state an active power state is set and a wake event signal is forwarded to other registered power clients. In one exemplary implementation the active state is again set by central power manager.

Thus, the present invention facilitates enhanced processor performance and power conservation. Expedited recovery from reduced power states is enabled and is operating system agnostic. A minimal power consuming always on domain facilitates expedited recovery while permitting convenient and efficient flexibility in altering power states of other domains and/or islands at various level of granularity and power conservation. Power reduction operations can also be distributed for even greater efficient interaction with components of a system.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. The listing of steps within method claims do not imply any particular order to performing the steps, unless explicitly stated in the claim.

What is claimed is:

1. A power control method comprising:
performing a reduced power detection process for detecting a reduced power state, wherein said reduced power state is associated with an expedited recovery;
performing a reduced power state entry process;
performing a reduced power state entry process; and
performing an expedited recovery process in accordance with detection of a recovery indication event.

2. A power control method of claim 1 wherein said power control method is operating system agnostic.

3. A power control method of claim 1 wherein said reduced power detection process comprises:
collecting status of different peripherals in a system by a central resource manager module;
instrumenting a scheduler idle loop to determine a system idle condition status by checking with said central resource management module; and
deciding to enter a reduce power state based upon a time for a next operating system tick and said system idle condition status.

4. A power control method of claim 1 wherein said reduced power state entry process comprises:
saving expedited recovery information in registers of an always on domain; and
putting a DRAM in self refresh mode to preserve a system context while a chip is turned off.

5. A power control method of claim 4 wherein said expedited recovery information comprises a reduced power state recover indication, system context information, a recovery code address indication, and recovery code validation information.

6. A power control method of claim 3 wherein said system context information comprises CPU status information, peripheral status information and other component information associated with restoring a system to a state to continue operations in an orderly sequence after powering up from said reduced power state.

7. A power control method of claim 1 wherein said expedited recovery process comprises:
determining whether to proceed with said expedited recovery process;
initialize memory controller registers and directing memory controller to exit self refresh;
validating system context recovered from memory using keys stored in an always on domain;
jumping to recovery instructions in memory; and
restoring operating system information and returning to operating system control.

8. A power control method of claim 7 wherein said determining whether to proceed with said expedited recovery process comprises:
checking an expedited recovery indication in an always on domain; and
proceeding with said expedited recovery process if said expedited recovery indication is set.

9. A power control method of claim 7 wherein said restoring operating system information comprises restoring processor and peripheral register information for interaction with the operating system in a state corresponding to last operational state before power reduction.

10. A power control method of claim 7 wherein said proceeding with said expedited recovery process includes indicating an expedited recovery transition to a central resource management module.

11. A power control system comprising:
an always on domain for storing information associated with initiation of an expedited recovery from a reduced power state; and
a power management unit for directing said expedited recovery from said reduced power state based upon an indication from said always on component.

12. A power control system of claim 11 where said information associated with initiation of an expedited recovery from a reduced power state includes a warm boot flag, a pointer to recovery code, recovery code validation information, pointer to context, context validation information, memory controller configuration, phase lock loop frequency and settling time, and power management unit safe voltage and worst case delay.

13. A power control system of claim 12 wherein said context information includes processor and peripheral register information for interaction with the operating system in a state corresponding to last operational state before power reduction

14. A power control system of claim 11 further comprising a boot ROM for storing a portion of instructions associated with said expedited recovery from said reduced power sate.

15. A power control system of claim 11 further comprising a memory for storing full expedited recovery information in a self refresh mode and forwarding said information to a resource management module in response to said initiation of said expedited recovery from said reduced power state.

16. A power control system of claim 15 wherein said memory is a DRAM for storing a portion of instructions associated with said expedited recovery from said reduced power sate, said DRAM entering a self refresh state upon entry of said reduced power state.

17. A power control method comprising:
setting a power state indicator to an idle value;
alternating between idle state associated with said idle value and active states based on power client requests;
determining if it is safe to enter a reduced power state based on said power sate indicator;
changing said power sate indicator value base upon entry to a reduced power state; and
exiting said reduced power state.

18. A power control method of claim 17 further comprising:
setting active power state; and
forwarding a wake event signal to other registered power clients.

19. A power control method of claim 17 wherein upon entry to said reduced power state changing said power state indicator to correspond to said reduced power state.

20. A power control method of claim 17 wherein said power state indicator indicates if a system is in a full power state or an expedited recovery full power state mode.
